(19) United States
(12) Patent Application Publication
(10) Pub. No.: US 2010/0132041 A1
(43) Pub. Date: May 27, 2010

(54) INTERCEPTION-BASED CLIENT DATA NETWORK SECURITY SYSTEM

(75) Inventors: Pao-Chuan Chu, Taipei (TW); Wen-Ho Yang, Taipei (TW); Chen-Kun His, Taipei (TW); Li-Jane Lai, Taipei (TW); Ming Chung, Taipei (TW)

Correspondence Address: PEARNE & GORDON LLP, 1801 EAST 9TH STREET, SUITE 1200, CLEVELAND, OH, 44114-3108, US

(73) Assignee: CHUNGHWA TELECOM CO., LTD., Taipei (TW)

(21) Appl. No.: 12/508,171

(22) Filed: Jul. 23, 2009

(30) Foreign Application Priority Data
Nov. 27, 2008 (TW) 097145877

(51) Int. Cl. G06F 21/00

(52) U.S. Cl. 726/24; 726/26; 726/15

(57) ABSTRACT

An interception-based client data network security system is provided, which includes a user end device, an interception device and a security center. The interception device performs interception of data packets from the user end device according to preset conditions and allows the intercepted data packets to be formedints event logs and then transmits the event logs to the security center for storage. And, the security center compares the stored event logs according to specific search commands for providing security services in correspondence with the stored event logs, thereby overcoming the drawbacks of conventional MPLS or mirror techniques in which the transfer of mass data packets causes overloading of the servers of the security center and excessive consumption of network bandwidth.

### BACKGROUND OF THE INVENTION

1. Field of the Invention

The present invention relates generally to client data network security systems, and more particularly to an interception-based client data network security system that provides security services in correspondence with intercepted data packets.

2. Description of Related Art

Use of the Internet has become nearly ubiquitous, so much so that Internet access is almost considered a standard utility service, like water or gas service. Generally, Internet users access the Internet through ISPs (Internet Service Providers) which are companies or organizations offering Internet access and network services to users. These companies buy connection equipment and rent lines and/or bandwidth to users. Generally, users connect to ISPs through fixed line or dial-up connections for Internet access.

However, the Internet is plagued by viruses and malicious programs. These viruses and malicious programs may cause failure at user end devices or alter the data of the user end devices. In addition, the unintended exposure of user data via various hacker attacks often occurs at or on the user end devices. In response, monitoring data packets to detect network activity has become an important defensive measure. For example, conventional mirror or MPLS techniques involve transferring data packets at specific interfaces or ports through network devices to a security center and analyzing the data packets so as to take follow-up actions in response to the analyzed result.

By transferring data packets directly through the network, the mirror and MPLS techniques can eliminate the need of user end installation of some settings or software. Instead, settings can be completed at the ISP end and various security devices can be applied so as to provide various services.

However, the above conventional techniques have the following drawbacks: (1) increased bandwidth consumption: The conventional techniques cannot identify the content of data packets. Instead, only after the data packets at specific interfaces or ports have been completely transferred to a security center can the content of the data packets be analyzed by the security center. However, the transfer of mass data packets over the network leads to significant consumption of network bandwidth; (2) overload of the security center: After all the data packets are transferred to the security center, the security center needs to perform a lot of analysis and comparison, thereby potentially resulting in overload of the security center if a lot of packets are received in a short period of time; and (3) low autonomy of users: Currently, the provision of data monitoring and other security services is dominated, controlled or constrained by ISPs. As such, it is not possible for users to establish security plans and select preset conditions for monitoring. Therefore, there is a need to provide a client data network security system to overcome the above drawbacks.

### SUMMARY OF THE INVENTION

According to the above drawbacks, the present invention provides an interception-based client data network security system that intercepts data packets from a user end device in compliance with preset conditions so as to form the intercepted data packets into event logs and then transmit the event logs to a security center, such that the security center can compare the content of the event logs according to specific search commands and provide security services in correspondence with the event logs.

The present invention provides an interception-based client data network security system, which comprises: a user end device; an interception device for intercepting data packets from the user end device in compliance with preset conditions and forming the intercepted data packets into event logs; and a security center for receiving and storing the event logs and providing security services in correspondence with the event logs to the user end device.

In a preferred embodiment, the interception device intercepts the data packets in compliance with the preset conditions according to specific keywords, so as for the intercepted data packets to transmit the event logs to the security center.

In another preferred embodiment, the interception-based client data network security system of the present invention further comprises a management device that is connected to the interception device for setting the preset conditions.

Compared with the prior art, the interception-based client data network security system of the present invention uses an interception device to intercept data packets in compliance with preset conditions according to specific keywords, so as for the intercepted data packets to transmit event logs to a security center for further comparison, thereby greatly reducing the packet data volume, increasing the efficiency of the utilized network bandwidth, and increasing operational efficiency of the servers of the security center.

### BRIEF DESCRIPTION OF DRAWINGS

FIG. 1 is a block diagram of an interception-based client data network security system according to the present invention;

FIG. 2 is a more detailed block diagram of an interception-based client data network security system according to a preferred embodiment of the present invention; and

FIG. 3 is an application diagram of the interception-based client data network security system according to the present invention.

### DETAILED DESCRIPTION OF PREFERRED EMBODIMENTS

The following illustrative embodiments are provided to illustrate the disclosure of the present invention. These and other advantages and effects will be apparent to those skilled in the art after reading the disclosure of this specification.

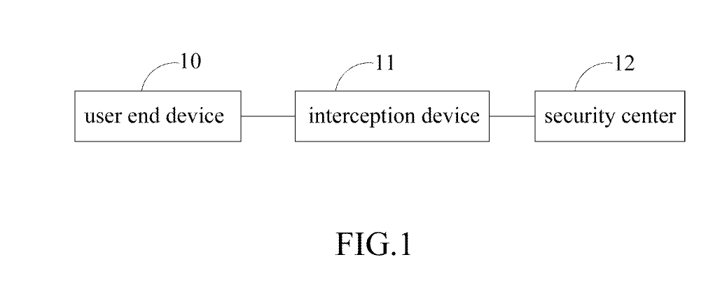

FIG. 1 is a diagram of an interception-based client data network security system according to the present invention. As shown in the drawing, the interception-based client data network security system comprises a user end device 10, an interception device 11 and a security center 12.

The user end device 10 is an electronic device that is capable of accessing and processing data, such as a desktop computer, a notebook computer, a digital TV device, a personal digital assistant and/or a mobile phone.

The interception device 11 is used for intercepting data packets from the user end device 10 in compliance with preset conditions so as for the intercepted data packets to form event logs.

The security center 12 is used for receiving and storing the event logs and providing security services in response to the event logs to the user end device 10.

In practice, the interception device 11 is disposed between the user end device 10 and the security center 12, and the preset conditions for interception should be established in advance. When the user end device 10 transmits data, the interception device 11 intercepts data packets from the user end device 10 in compliance with the preset conditions so as for the intercepted data packets to form event logs and then transmits the event logs to the security center 12, such that the security center 12 can compare and analyze the event logs. Generally, packet data can be searched by comparison with keywords, and different comparisons generate different effects. For example, detection and examination of secret files could possibly be achieved by scanning the data for the word ‘secret,’ an anti-virus detection function could be achieved through comparison of the data with specific virus codes, and an intrusion detection function could be achieved through comparison of the data with particular intrusion keywords. Further, after the security center receives the event logs from the interception device, it performs an early warning mechanism so as to inform the user end device 10 to carry out immediate corresponding measures when security violations are detected.

In a preferred embodiment, the security services provided by the security center 12 comprise: virus detection, data exposure detection, content filtering detection, virus infected webpage detection, mail detection and/or intrusion detection.

In another preferred embodiment, the user end device 10 can be a workstation, a desktop computer, a notebook computer, a personal digital assistant and/or a mobile phone.

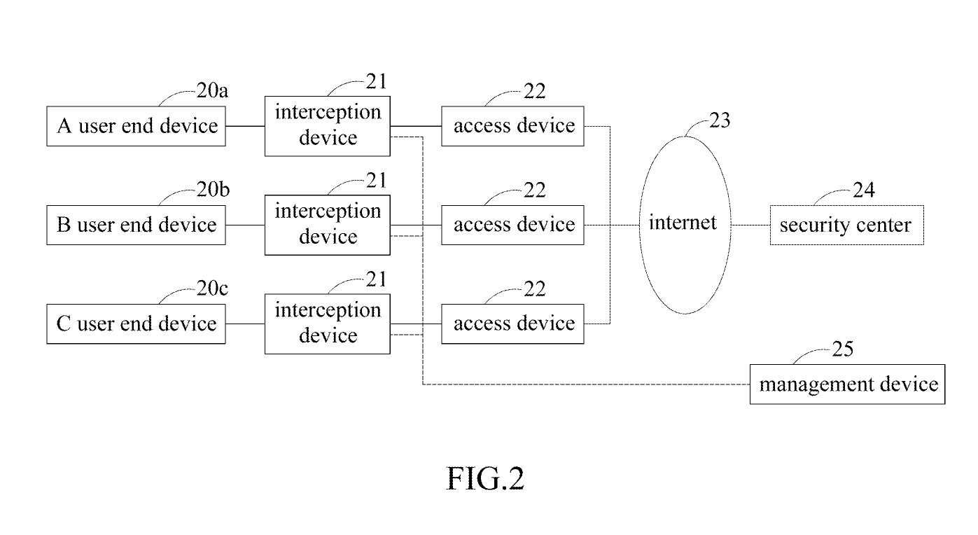

FIG. 2 shows an interception-based client data network security system according to a preferred embodiment of the present invention. As shown in the drawing, the interception-based client data network security system of the present embodiment comprises an A user end device 20a, a B user end device 20b, a C user end device 20c, an interception device 21, an access device 22, the Internet 23, a security center 24 and a management device 25. Therein, the access device 22 is an ATU-R or a router, and the management device 25 is a device disposed at the ISP end and authorized to manage the interception device 21.

In practice, the A user end device 20a, B user end device 20b and C user end device 20c are users having the privilege of interception security services. Firstly, the interception device 21 must be configured at the user ends and, further, the users are connected to the Internet 23 through the access device 22. Then, the management device 25 sets the preset conditions for the interception device 21 according to the service content applied or selected by the users. Finally, when the interception device 21 finds data packets matching the preset conditions, it performs interception so as for the intercepted data packets to form event logs and transmit the event logs to the security center 24.

For example, in the case that the A user end device 20a requires data exposure detection, the interception device 21 is installed and specific keyword comparisons are used as the preset conditions. When the A user end device 20 transmits data packets, the interception device 21 intercepts data packets having the specific keywords and forms the intercepted data packets into event logs and then transmits the event logs to the security center 24. Accordingly, the database in the security center 24 can be searched so as to determine whether data exposure occurs to the A user end device 20. Alternatively, if the security center 24 concludes that data packets that are being transmitted by the A user end device 20 have a high probability of being exposed, such as that sent by a malicious spyware program that has captured sensitive information, then the security center 24 will send a command to the interception device 21 to block the packet transmission.

In a preferred embodiment, the interception device 21 intercepts data packets according to specific keywords, so as for the intercepted data packets to form event logs and transmit the event logs to the security center 24, allowing the security center 24 to compare the stored event logs according to specific search commands.

In another preferred embodiment, when the interception device 21 intercepts specific data packets, it blocks the data packets. Further, the security center 24 can instruct the interception device 21 to unblock the data packets when a certain condition is met, that is, override the blocking function.

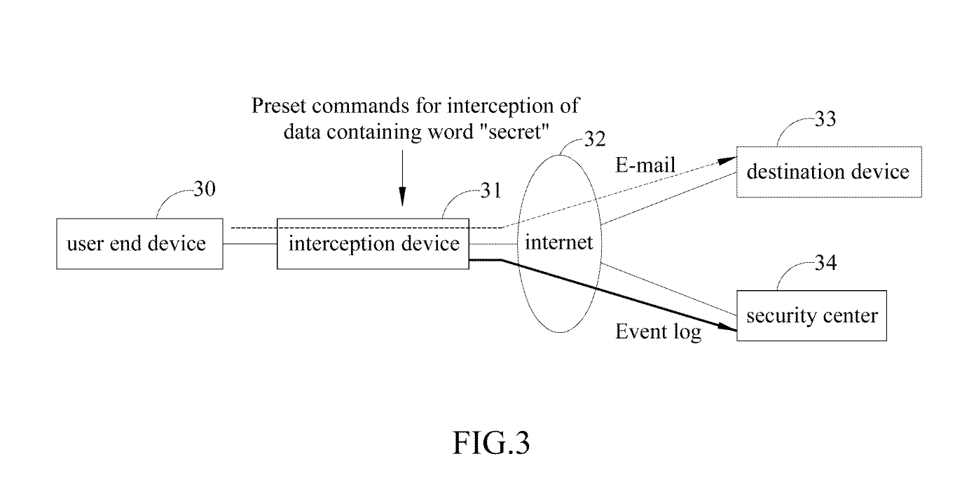

FIG. 3 shows an application diagram of the interception-based client data network security system according to a preferred embodiment of the present invention. The system comprises a user end device 30, an interception device 31, the Internet 32, a destination device 33 and a security center 34.

The interception-based client data network security system of the present embodiment can be applied to an internal control and protection mechanism in an enterprise. Generally, in order to protect internal data, enterprises need to set up various kinds of equipment to analyze employee behavior. But, with the application of the present invention, such enterprises only need to set up the interception device 31 at the user end so as to intercept and transmit data packets to the remote security center 34 for centralized analysis and processing, and the centralized server end can have various analysis mechanisms, thereby effectively reducing the amount of equipment and saving manpower. Further, the present invention can pre-screen data from user end devices, wherein only qualified pre-screened data is intercepted and transmitted to the server end, thereby eliminating the need of transmitting all the data to the server end and reducing the load on the network.

For example, the employee turnover in the real estate brokerage industry is high, which leads to a high risk of data leakage. Therefore, most real estate brokerages try to protect confidential information from leaking via, for example, e-mail or instant messaging programs. Through the present invention, specific data can be intercepted and transmitted to a remote security center for comparison with preset conditions, thereby determining whether a leak possibility exists due to malicious software on the devices or from rogue or careless employees, thus reducing the possibility of data exposure.

In practice, first, the preset commands that require the interception device 31 to perform interception are sent to the interception device 31, such as a command to detect when the word ‘secret’ is sent. Then, when the user end device 30 sends e-mail to the destination device 33 through the Internet 32, the interception device 31 examines the content of the e-mail. If it finds an e-mail matching the preset conditions, an event log is formed and transmitted to the security center 34.

In a preferred embodiment, the user end device 30 is authorized to connect to the security center 34 and examine or query the event logs.

In another preferred embodiment, the user end device 30 and the interception device 31 are connected to the security center 34 through a virtual private network (VPN), a local area network (LAN), a wide area network (WAN) or a wireless network.

In summary, the interception-based client data network security system of the present invention achieves the following effects: (1) increasing the usage efficiency of bandwidth: Since the conventional techniques transfer all the data packets at specific ports to a security center for analysis, the transfer of data packets can lead to overload of the network bandwidth as well as decreased efficiency in terms of desired data transmitted verses overall data. In contrast, the present invention can prescreen data from the user end devices and then intercept and transmit the qualified prescreened data to the server end, thereby eliminating the need of transmitting all the data to the server end and accordingly increasing the usage efficiency of bandwidth; (2) decreasing the load of the security center: The conventional techniques transfer all the data packets to the security center and accordingly the security center needs to perform a lot of analysis and comparison, thereby potentially resulting in overload of the servers of the security center. In contrast, the present invention only intercepts data packets matching specific preset commands, thereby greatly reducing the data volume transmitted to and stored in the security center and decreasing the load of the security center; and (3) increasing autonomy of users: The interception-based client data network security system can not only be set up by an ISP, it can also be set up inside an enterprise without the need of an ISP intervening. As a result, the enterprise can conveniently modify preset commands and examine event logs, thereby increasing the autonomy of users.

The above-described descriptions of the detailed embodiments are only to illustrate the preferred implementation according to the present invention, and they are not to limit the scope of the present invention. Accordingly, various modifications and variations completed by those with ordinary skill in the art fall within the scope of present invention as defined by the appended claims.

What is claimed is:

1. An interception-based client data network security system, comprising:
a user end device;
an interception device for intercepting data packets from the user end device in compliance with preset conditions and forming the intercepted data packets into event logs; and
a security center for receiving and storing the event logs from the interception device, so as to provide security services to the user end device in correspondence to the stored event logs.

2. The system of claim 1, wherein the interception device intercepts the data packets in compliance with the present conditions according to predetermined keywords so as to transmit the event logs to the security center.

3. The system of claim 1, wherein the security center is configured for comparing content of the stored event logs with specific search commands.

4. The system of claim 1, wherein the security services provided by the security center are virus detection, data exposure detection, content filtering detection, virus infected webpage detection, e-mail detection and/or intrusion detection.

5. The system of claim 1, wherein the user end device is one selected from the group consisting of a workstation, a desktop computer, a notebook computer, a personal digital assistant, and a mobile phone.

6. The system of claim 1, wherein the interception device is further capable of blocking the data packets intercepted by the interception device from being transmitted.

7. The system of claim 6, wherein the security center is further capable of instructing the interception device to unblock the data packets intercepted by the interception device that are in compliance with the present conditions.

8. The system of claim 1, wherein the user end device is authorized to connect to the security center to inspect the event logs.

9. The system of claim 1, wherein the user end device and the interception device are connected to the security center through a virtual private network (VPN), a local area network (LAN), a wide area network (WAN) or a wireless network.

10. The system of claim 1, further comprising a management device that is connected to the interception device for configuring the preset conditions.
